(19) United States
(12) Patent Application Publication
(10) Pub. No.: US 2013/0174119 A1
(43) Pub. Date: Jul. 4, 2013

(54) COMPUTING DEVICE AND METHOD FOR AUTOMATICALLY GENERATING MEASURING PROGRAMS

(71) Applicants: HONG FU JIN PRECISION INDUSTRY (ShenZhe, Shenzhen City (CN); HON HAI PRECISION INDUSTRY CO., LTD., New Taipei (TW)

(72) Inventors: CHIH-KUANG CHANG, Tu-Cheng (TW); ZHONG-KUI YUAN, Shenzhen City (CN); NA YU, Shenzhen City (CN); LI JIANG, Shenzhen City (CN); JIAN-HUA LIU, Shenzhen City (CN)

(73) Assignees: HON HAI PRECISION INDUSTRY CO., LTD., New Taipei (TW); HONG FU JIN PRECISION INDUSTRY (ShenZhen) CO. LTD., Shenzhen City (CN)

(21) Appl. No.: 13/670,456

(22) Filed: Nov. 7, 2012

(30) Foreign Application Priority Data
Dec. 30, 2011 (CN) 201110456009.X

(51) Int. Cl. G06F 9/44

(52) U.S. Cl. 717/109

(57) ABSTRACT

In a computing device, a script editor of a measuring software is executed and a macro option of the script editor is selected to show a macro interface. The macro interface is initialized for loading all data types and loading all macro names. Variable names are inputted and variable types are selected through the macro interface to generate variable declarations. The received variable names are then added into the macro interface. A macro name and a variable name is selected through the macro interface and the selected variable name is assigned to a macro corresponding to the selected macro name. One or more variables are inputted into the macro to execute the macro, then, results of executing the macro are outputted through the macro interface. Finally, a measuring program of a product is generated according to the above operation.

### BACKGROUND

1. Technical Field

Embodiments of the present disclosure relate to measurement technology, and more particularly to a computing device and method for automatically generating a measurement program of a product.

2. Description of Related Art

Measurements of manufactured products using a measuring software, such as image measuring software, can be helpful to determine if the manufactured products meet design specifications, to provide product information for improvements in the process of the product quality control.

For providing more product information, a plurality of compatible manufactured parts need to be measured. Thus, repeated operations must be performed manually. Therefore, a measuring program is needed for redundant manual operations.

In order to compile the measuring program, a measuring process of measuring one of the plurality of manufactured products needs to be recorded, and a designer needs to compile the measuring program according to the measuring process. However, the process of manually compiling the measuring program is complex and inefficient”.

### BRIEF DESCRIPTION OF THE DRAWINGS

FIG. 1 is a schematic block diagram of one embodiment of a computing device including a program generation system.

FIG. 2 is a schematic block diagram of one embodiment of function modules of the program generation system included in the computing device of FIG. 1.

FIGS. 3A and 3B are flowcharts of one embodiment of a method for automatically generating a measuring program of a product using the computing device 1 of FIG. 1.

FIG. 4 illustrates a schematic diagram illustrating an example of a macro interface.

### DETAILED DESCRIPTION

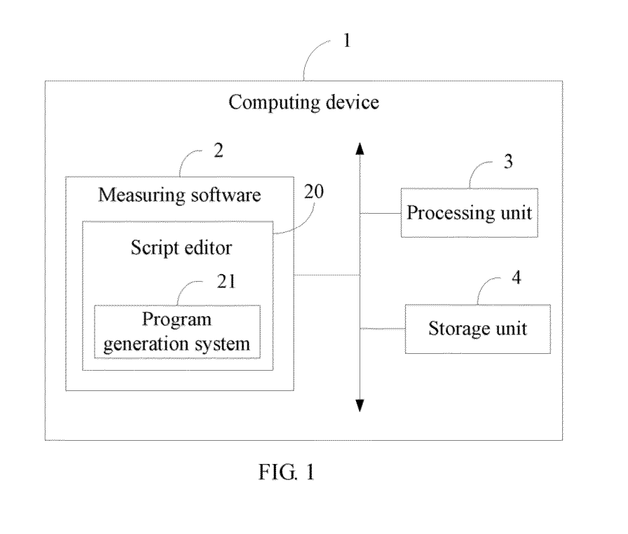

FIG. 1 is a schematic block diagram of one embodiment of an computing device 1. The computing device 1 includes a measuring software 2, a processing unit 3, and a storage unit 4. The measuring software may be an image measuring software, and includes a script editor 20. The script editor 20 is embedded with a program generation system 21.

It should be understood that FIG. 1 illustrates only one example of the computing device 1, which may include more or fewer components than illustrated, or a different configuration of the various components in other embodiments. The computing device 1 may be a computer, a server, or any other computing device.

The program generation system 21 may include computerized instructions in the form of function modules that are executed by the processing unit 3 and stored in the storage unit 4. The processor unit 3 may include a processor, a microprocessor, an application-specific integrated circuit (ASIC), and a field programmable gate array (FPGA), for example. Some non-limiting examples of the storage unit 4 include CDs, DVDs, BLU-RAY, flash memory, hard disk drives, and other suitable non-transitory computer-readable medium. A detailed description of the program generation system 21 will be given in the following paragraphs.

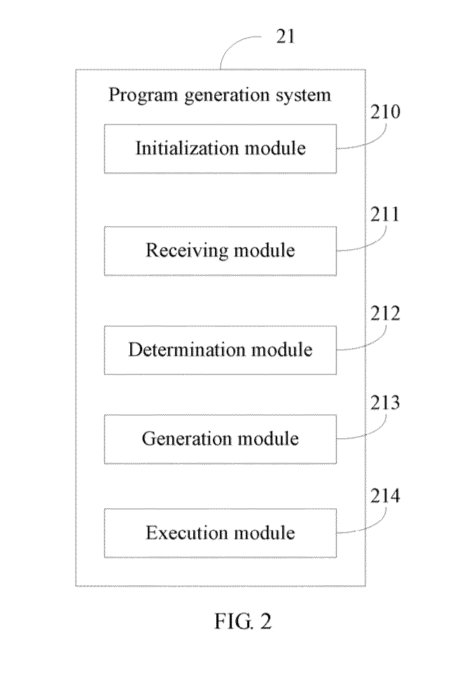

FIG. 2 is a schematic block diagram of one embodiment of function modules of the program generation system 21. In one embodiment, the program generation system 21 may include, for example, an initialization module 210, a receiving module 211, a determination module 212, a generation module 213, and an execution module 214.

In general, the word “function module” as used herein, refers to logic embodied in hardware or firmware, or to a collection of software instructions, written in a programming language, such as, Java, C, or assembly.

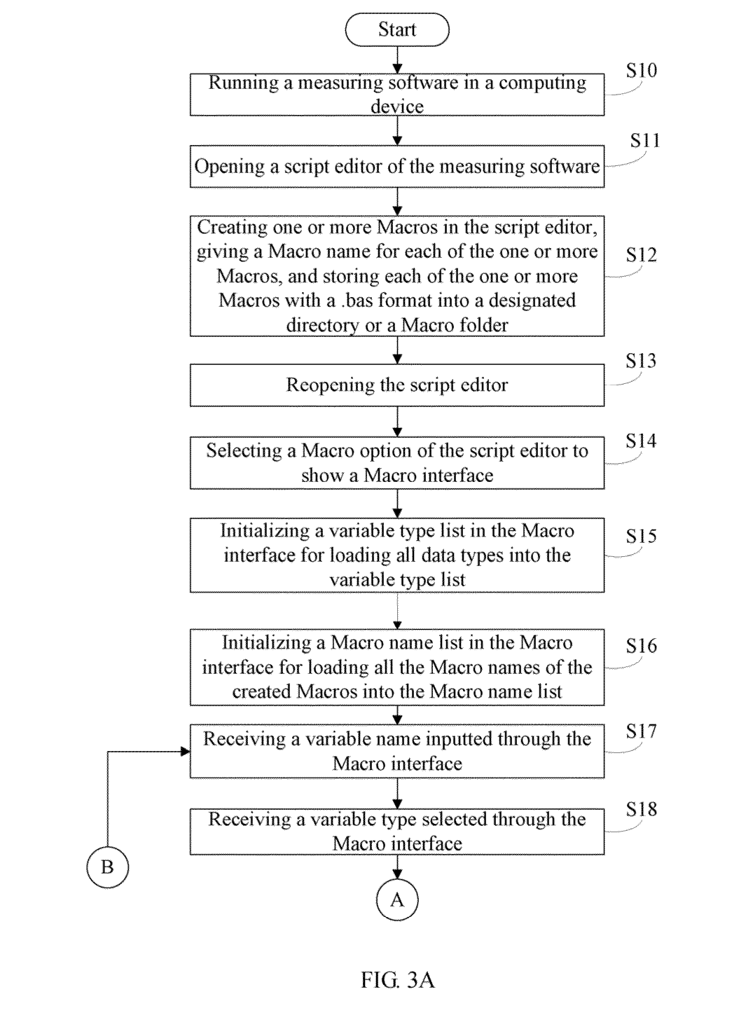

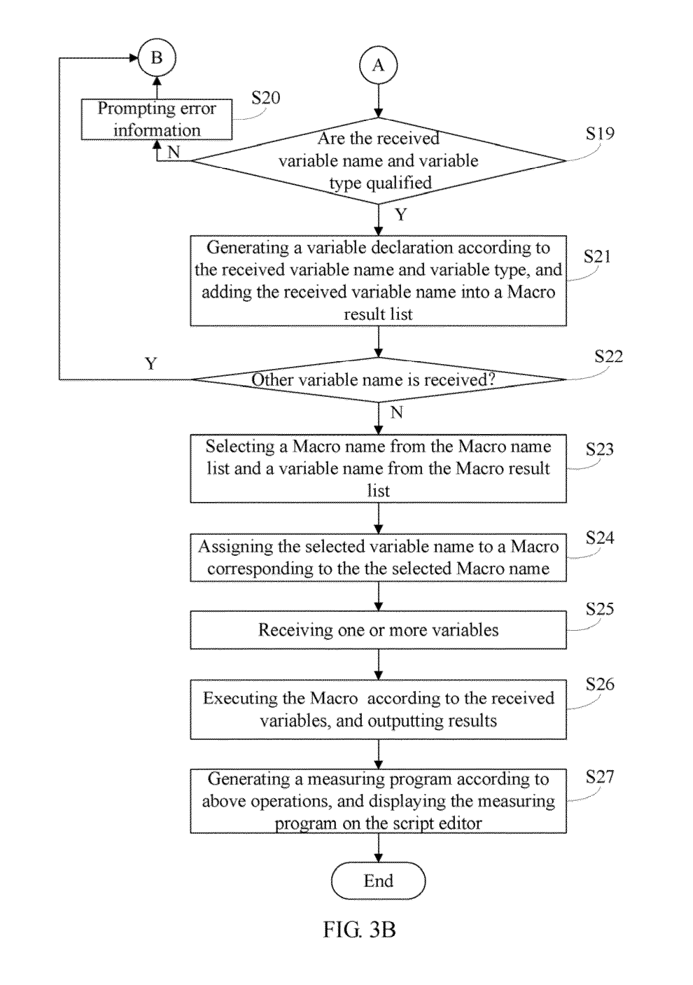

The function modules 210-214 of the program generation system 21 have function of automatically generating a measuring program using a pre-created macro according to variables and variable types designated by a user. Detailed functions of the function modules 210˜214 are illustrated in FIGS. 3A and 3B and described below.

FIGS. 3A and 3B are flowcharts of one embodiment of a method for automatically generating a measuring program of a product using the computing device 1 of FIG. 1. Depending on the embodiment, additional steps may be added, others removed, and the ordering of the steps may be changed.

In step S10, the measuring software 2 runs in the computing device 1, and in step S11, the script editor 20 of the measuring software 2 is opened.

In step S12, one or more macro s are created in the script editor 20, and each of the one or more macro s is given a macro name and stored into a designated directory or a macro folder of the storage unit 4. One example of a created macro which is given a macro name “kk” may be described as:

### Function kk (a Integer, b Integer) Integer;

Return a+b;

### End Function.

It may be understood that each of the one or more created macros stored in the designated directory or the macro folder can be invoked repeatedly to execute a particular function for measuring the product, such as computing a length, an angle, for example. Thus, if a macro having an intended function has originally existed in the designated directory or the macro folder, steps S10-S12 can be omitted.

In step S13, the script editor 20 is reopened when the product is measured using the measuring software 2.

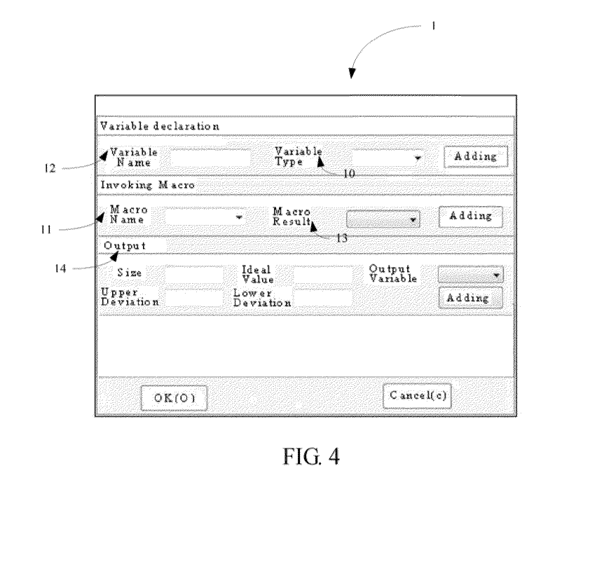

In step S14, a macro option of the script editor 20 is selected to show a macro interface. An example of the macro interface is shown in FIG. 4. As illustrated in FIG. 4, the macro interface 1 has fields of a “Variable Name” box 12 to receive variable names inputted by a user, a “Variable Type” list 10 to list data types for being selected by the user, a “macro Name” list 11 to list macro names for being selected by the user, a macro result list 13 to list the variable names inputted by the user, and an output column 14 to output result of executing the created macros.

In step S15, the initialization module 210 initializes the variable type list 10 in the macro interface for loading all data types into the variable type list. The data types may include Integer, Long, Single, Double, for example.

In step S16, the initialization module 210 initializes the macro name list 11 in the macro interface for loading all the macro names of the created macros stored in the designated directory or macro folder into the macro name list 11.

In step S17, the receiving module 211 receives a variable name inputted through the variable name box 12 of the macro interface. The received variable name may be “a”, “b”, or “c”, for example.

In step S18, the receiving module 211 receives a variable type of the received variable name selected through the variable type list 10 of the macro interface. If the received variable type is Integer, it means that the received variable a, b, or c is an integer.

In step S19, the determination module 212 determines whether the received variable name and variable type are qualified. In one embodiment, if the created macros are written in a particular programming language, the determination module 122 determines whether the received variable name and variable type comply with the rules of the particular programming language. The determination module 122 determines that the received variable name and variable type are not qualified when the variable name and variable type do not comply with the rules of the particular programming language, step S20 is implemented. The determination module 122 determines that the received variable name and variable type are qualified when the variable name and variable type comply with the rules of the particular programming language, step S21 is implemented.

In step S20, the determination module 212 displays an error information on the macro interface, and then the procedure goes to step S17.

In step S21, the generation module 213 generates a variable declaration according to the received variable name and variable type, and adds the received variable name into the macro result list 13 of the macro interface. The variable declaration may be, for example, “Dim a integer”, “Dim b integer”, “Dim c integer”, for example.

In step S22, the determination module 212 determines if other variable name is received. If another one variable name is inputted through the variable name box 12 of the macro interface, step S17 is repeated. Otherwise, if no variable name is inputted through the variable name box 12 of the macro interface, step S23 is implemented.

In step S23, the receiving module 211 receives a macro name, such as “kk”, selected from the macro name list 12, and receives a variable name, such as “c” selected from the macro result list 13.

In step S24, the generation module 213 assigns the selected variable name to a macro corresponding to the selected macro name, such as c=Load macro (“kk”).

In step S25, the receiving module 211 receives one or more variables inputted into the macro that corresponds to the selected macro name.

In step S26, the execution module 214 executes the macro according to the received variables, and output results in the output column 14 of the macro interface.

In step S27, the generation module 213 generates a measuring program of the product according to the above operation, and displays the measuring program on the script editor 20.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computerized method for automatically generating a measuring program of a product, the method being executed by at least one processor of a computing device which is installed with a measuring software, the measuring software comprising a script editor, the method comprising:
opening the script editor and selecting a macro option of the script editor to show a macro interface;
initializing the macro interface for loading all data types and loading all macro names of macros stored in a designated directory of the computing device;
receiving variable names inputted through the macro interface, and selecting variable types through the macro interface;
generating variable declarations according to the received variable names and the selected variable types, and adding the received variable names into the macro interface;
selecting a macro name and a variable name through the macro interface;
assigning the selected variable name to a macro corresponding to the selected macro name;
receiving one or more variables inputted into the macro that corresponds to the selected macro name, executing the macro according to the received variables, and outputting results of the executed macro through the macro interface; and
generating a measuring program of the product according to the above operations, and displaying the measuring program on the script editor.

2. The method according to claim 1, before the opening step further comprising:
creating the macros in the script editor, giving macro name to each of the one or more macros, and storing the macros into the designated directory of the computing device for loading into the macro interface.

3. The method according to claim 1, further comprising:
determining if the received variable names and the selected variable types are qualified; and
prompting error information when either of the received variable names and the selected variable types is qualified.

4. The method according to claim 1, wherein the macro interface comprises fields of a Variable name box to receive the variable names, a variable type list to list the data types for being selected, a macro name list to list the macro names for being selected, a macro result list to list the variable names, and an output column to output the results of executing the macro.

5. A computing device, comprising:
a measuring software, the measuring software comprising a script editor;
a storage unit;
at least one processor; and
one or more modules that are stored in the storage unit and are executed by the at least one processor, the one or more modules comprising instructions to:
open the script editor and select a macro option of the script editor to show a macro interface;
initialize the macro interface for loading all data types and loading all macro names of macros stored in a designated directory of the computing device;
receive variable names inputted through the macro interface, and select variable types through the macro interface;
generate variable declarations according to the received variable names and the selected variable types, and add the received variable names into the macro interface;
select a macro name and a variable name through the macro interface;
assign the selected variable name to a macro corresponding to the selected macro name;
receive one or more variables inputted into the macro that corresponds to the selected macro name, execute the macro according to the received variables, and output results of the executed macro through the macro interface; and
generate a measuring program of a product according to the above operations, and display the measuring program on the script editor.

6. The computing device according to claim 5, wherein the one or more modules further comprise instructions to:
create the macros in the script editor, give a macro name to each of the one or more macros, and store the macros into the designated directory for loading into the macro interface.

7. The computing device according to claim 5, wherein the one or more modules further comprise instructions to:
determine if the received variable names and the selected variable types are qualified; and
prompt error information when either of the received variable names and the selected variable types is qualified.

8. The computing device according to claim 5, wherein the macro interface comprises fields of a variable name box to receive the variable names, a variable type list to list the data types for being selected, a macro name list to list the macro names for being selected, a macro result list to list the variable names, and an output column to output the results of executing the macro.

9. A non-transitory storage medium having stored thereon instructions that, when executed by a processor of a computing device, causes the processor to perform a method for automatically generating a measuring program of a product, the method comprising:
opening a script editor of a measuring software installed in the computing device, and selecting a macro option of the script editor to show a macro interface;
initializing the macro interface for loading all data types and loading all macro names of macros stored in a designated directory of the computing device;
receiving variable names inputted through the macro interface, and selecting variable types through the macro interface;
generating variable declarations according to the received variable names and the selected variable types, and adding the received variable names into the macro interface;
selecting a macro name and a variable name through the macro interface;
assigning the selected variable name to a macro corresponding to the selected macro name;
receiving one or more variables inputted into the macro that corresponds to the selected macro name, executing the macro according to the received variables, and outputting results of the executed macro through the macro interface; and
generating a measuring program of a product according to the above operation, and displaying the measuring program on the script editor.

10. The non-transitory storage medium according to claim 9, where before the opening step, the method further comprises:
creating the macros in the script editor, giving macro name to each of the one or more macros, and storing the macros into the designated directory for loading into the macro interface.

11. The non-transitory storage medium according to claim 9, wherein the method further comprises:
determining if the received variable names and the selected variable types are qualified; and
prompting error information when either of the received variable names and the selected variable types is qualified.

12. The non-transitory storage medium according to claim 9, wherein the macro interface comprises fields of a variable name box to receive the variable names, a variable type list to list the data types for being selected, a macro name list to list the macro names for being selected, a macro result list to list the variable names, and an output column to output the results of executing the macro.
